(19) United States
(12) Patent Application Publication
(10) Pub. No.: US 2025/0020458 A1
(43) Pub. Date: Jan. 16, 2025

(54) STATE DETERMINATION DEVICE, CONDITION DETERMINATION METHOD, AND RECORDING MEDIUM

(71) Applicant: NEC Corporation, Minato- ku, Tokyo (JP)

(72) Inventors: Chisato Sugawara, Tokyo (JP); Yosuke Kimura, Toky (JP); Toshimichi Yokote, Tokyo (JP); Takakazu Ishii, Tokyo (JP); Daisuke Hashizume, Tokyo (JP); Hiromichi Hirata, Tokyo (JP); Shouhei Ohno, Tokyo (JP); Nana Jumonji, Tokyo (JP)

(73) Assignee: NEC Corporation, Minato- ku, Tokyo (JP)

(21) Appl. No.: 18/711,912

(22) PCT Filed: Dec. 2, 2021
(86) PCT No.: PCT/JP2021/044221

§ 371 Date: May 21, 2024

(51) Int. Cl. G01B 21/32; G01C 21/00; G01C 21/34; G01S 13/90

(52) U.S. Cl. CPC G01B 21/32; G01C 21/3461; G01C 21/3815; G01S 13/9011

(57) ABSTRACT

This state determination device comprises: a ground surface information acquisition means that acquires ground surface displacement using a measurement image acquired from a ground surface measurement device; a region setting means for setting, on the basis of ground surface displacement, the quantity of sensor information processed for each prescribed region, the quantity being used in processing for acquiring the sensor information from a sensor information acquisition device; a sensor information processing means that processes the sensor information on the basis of the quantity of the sensor information processed that corresponds to each of the set regions; a state determination means that determines the state of a structure using the processed sensor information; and an output means that outputs the determined state of the structure.

### TECHNICAL FIELD

The present disclosure relates to a state determination device, a condition determination method, and a recording medium.

### BACKGROUND ART

There is a technology of grasping a state of a predetermined region on the ground from an image acquired by a synthetic aperture radar (hereinafter, referred to as “SAR”). For example, PTL 1 discloses a technology of extracting a region in which a state of a ground surface acquired by a radar device such as an SAR has changed with the lapse of time.

Meanwhile, there is a technology of determining a state of a road or a runway by using an image acquired by a drive recorder mounted on a vehicle. For example, PTL 2 discloses an in-vehicle device that performs image recognition processing on an image captured by a camera or the like provided in a host vehicle, and detects an abnormal state of a road such as road depressions or occurrence of other disasters.

### CITATION LIST

### Patent Literature

PTL 1: WO 2008/016034 A1
PTL 2: JP 2010-049442 A

### SUMMARY OF INVENTION

### Technical Problem

However, determination using the SAR cannot grasp a detailed state of a road surface or the like. On the other hand, although determination using the drive recorder can grasp a detailed state of a structure such as a road surface, a data processing amount in analysis using the drive recorder is large. In addition, an examination range includes a region to be examined in detail and a region that may be examined roughly to some extent. However, in examination using the drive recorder, it is not possible to grasp a region to be examined in detail in advance.

An object of the present disclosure is to provide a state determination device and the like that enable appropriate state determination of a structure while reducing a data processing amount.

### Solution to Problem

A state determination device according to an aspect of the present invention includes ground surface information acquisition means that acquires a ground deformation by using a measurement image acquired from a ground measurement device, region setting means that sets, for each predetermined region, a sensor information processing amount to be used in processing of acquiring sensor information from a sensor information acquisition device based on the ground deformation, sensor information processing means that processes the sensor information based on the sensor information processing amount associated to the set region, state determination means that determines a state of a structure by using the processed sensor information, and output means that outputs the determined state of the structure.

A condition determination method according to an aspect of the present invention includes acquiring a ground deformation by using a measurement image acquired from a ground measurement device, setting, for each predetermined region, a sensor information processing amount to be used in processing of acquiring sensor information from a sensor information acquisition device based on the ground deformation, processing the sensor information based on the sensor information processing amount associated to the set region, determining a state of a structure by using the processed sensor information, and outputting the determined state of the structure.

A recording medium according to an aspect of the present invention records a program for causing a computer to execute acquiring a ground deformation by using a measurement image acquired from a ground measurement device, setting, for each predetermined region, a sensor information processing amount to be used in processing of acquiring sensor information from a sensor information acquisition device based on the ground deformation, processing the sensor information based on the sensor information processing amount associated to the set region, determining a state of a structure by using the processed sensor information, and outputting the determined state of the structure.

### Advantageous Effects of Invention

An example of an effect of the present disclosure is to enable appropriate state determination of a structure while reducing a data processing amount.

### BRIEF DESCRIPTION OF DRAWINGS

FIG. 1 is a block diagram illustrating an example of a configuration of a state determination device according to a first example embodiment.

FIG. 2 is a conceptual diagram illustrating an example of a configuration of a state determination device according to the first example embodiment and a periphery thereof.

FIG. 3 is a diagram for describing an example of acquisition of sensor information by a sensor information processing unit according to the first example embodiment.

FIG. 4 is a diagram illustrating an example of an output of an output unit according to the first example embodiment.

FIG. 5 is a diagram illustrating another example of the output of the output unit according to the first example embodiment.

FIG. 6 is a diagram illustrating another example of the output of the output unit according to the first example embodiment.

FIG. 7 is a flowchart illustrating an example of an operation of the state determination device according to the first example embodiment.

FIG. 8 is a block diagram illustrating an example of a hardware configuration of the state determination device according to the first example embodiment.

FIG. 9 is a block diagram illustrating an example of a configuration of a state determination device according to a second example embodiment.

FIG. 10 is a diagram illustrating an example of route information according to the second example embodiment.

FIG. 11 is a flowchart illustrating an example of an operation of the state determination device according to the second example embodiment.

### EXAMPLE EMBODIMENT

### First Example Embodiment

A first example embodiment of the present invention will be described with reference to the drawings.

### [Description of Configuration]

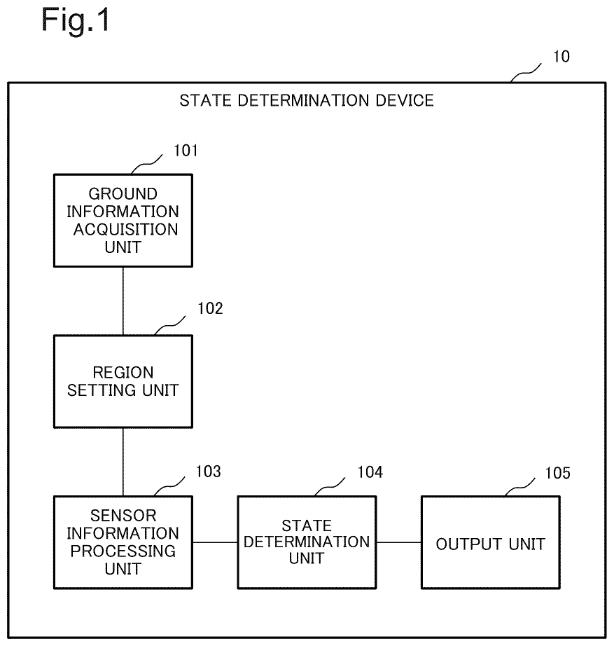

FIG. 1 is a block diagram illustrating an example of a configuration of a state determination device 10 according to the first example embodiment. The state determination device 10 includes a ground information acquisition unit 101, a region setting unit 102, a sensor information processing unit 103, a state determination unit 104, and an output unit 105. Note that each component may store at least some of information specified by each configuration, acquired information, and determined information in a storage unit (not illustrated). In this case, each component may acquire necessary information from the storage unit. The state determination device 10 is a device for determining a state such as deterioration of a structure based on sensor information acquired from a sensor information acquisition device. Examples of the structure include a civil structure such as a road, a bridge, a slope stabilization structure, an embankment, a pier, a revetment, or a runway.

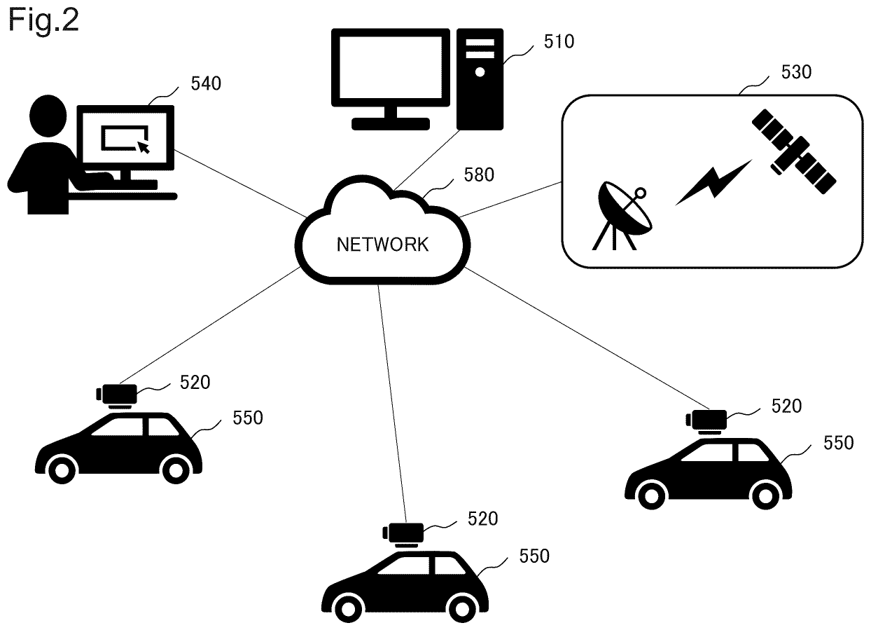

FIG. 2 is a conceptual diagram illustrating an example of a configuration of the state determination device 10 according to the first example embodiment and a periphery thereof. As illustrated in FIG. 2, the state determination device 10 is used as a system including a computer 510, a drive recorder 520 as an example of the sensor information acquisition device, an SAR 530, a terminal device 540 as an example of a display device, and a vehicle 550 as an example of a mobile object. A network 580 is a communication path that connects devices and systems to each other. The state determination device 10 (computer 510) and the drive recorder 520 may be directly connected to each other in some cases, and may be connected to each other via a cloud or the like in some cases.

The drive recorder 520 outputs the sensor information to the state determination device 10. The drive recorder 520 is mounted on a mobile object, for example, and acquires the sensor information. Examples of the mobile object include a vehicle and a drone. Furthermore, the sensor information may be acquired using a fixed camera such as an omnidirectional camera or an in-vehicle camera attached to the mobile object, or a camera mounted on a smartphone or a tablet carried by a person or the like in the mobile object, instead of the drive recorder 520.

The SAR 530 is a radar system that transmits and receives radio waves while a flying object such as an artificial satellite or an aircraft is moving, and obtains an image equivalent to that in a case of an antenna having a large opening. The SAR 530 outputs a measurement image (SAR image) or a ground deformation to the state determination device 10.

The terminal device 540 displays information regarding the state of the structure output by the state determination device 10. The terminal device 540 may be any device as long as the information regarding the state of the structure can be displayed. The terminal device 540 may be a terminal device of a road manager such as a local government.

The number of components included in FIG. 2 is an example. For example, the number of drive recorders 520 may be one or more. Alternatively, at least some of the drive recorders 520 do not have to be mounted on the vehicle 550. In FIG. 2, the drive recorder 520 is illustrated as being located outside the vehicle 550 for easy understanding. However, the drive recorder 520 may be mounted inside the vehicle 550.

Returning to FIG. 1, the ground information acquisition unit 101 acquires a ground deformation by using a measurement image acquired from a ground measurement device. Specifically, the ground information acquisition unit 101 acquires an SAR image from the SAR 530, and analyzes the acquired SAR image to acquire the ground deformation. Alternatively, the ground information acquisition unit 101 may directly acquire the ground deformation from the SAR 530. The ground information acquisition unit 101 may acquire, as the ground deformation, a maximum value or an average value of the ground deformation in units of grids obtained by drawing grid lines at equal intervals on a map to divide sections. Alternatively, the ground information acquisition unit 101 may acquire the ground deformation of only a road surface region on the map. The ground information acquisition unit 101 may acquire an observation result using multispectral imaging from the SAR 530. In this case, the ground information acquisition unit 101 may analyze the type of the ground in addition to the ground deformation by using the acquired observation result. The ground information acquisition unit 101 outputs the acquired ground deformation to the region setting unit 102. Further, the ground information acquisition unit 101 may acquire the ground deformation by using an SAR image stored in a cloud system configured using cloud computing to which the drive recorder 520 is connected.

The region setting unit 102 sets a sensor information processing amount to be used in processing of acquiring the sensor information from the sensor information acquisition device for each predetermined region based on the ground deformation acquired by the ground information acquisition unit 101. In the present disclosure, the predetermined region is a region specified according to the magnitude of the ground deformation. For example, the region setting unit 102 specifies a region with a large ground deformation based on the ground deformation acquired by the ground information acquisition unit 101. For example, the region setting unit 102 specifies a region whose ground deformation such as ground sinking is larger than a predetermined threshold in a region for which the SAR image is acquired. Alternatively, in consideration of an error, the region setting unit 102 may specify a region whose ground deformation is larger than a threshold and a predetermined range (for example, a range of several tens of meters) around the region. The magnitude of the ground deformation is expressed by, for example, a ground deformation speed or an accumulated ground deformation amount. The ground deformation speed is the degree of change in ground deformation (sinking or swelling) with respect to time (for example, mm/year). The region setting unit 102 may specify a region in which the ground is rapidly deformed and the ground deformation moves non-linearly even if the region is not a region whose ground deformation is larger than the threshold.

Next, the region setting unit 102 sets the sensor information processing amount to be used in the processing of acquiring the sensor information from the sensor information acquisition device for the specified region and other regions. The region setting unit 102 may specify a plurality of regions instead of one region. In addition, the region setting unit 102 may specify several types of regions according to the magnitude of the ground deformation. In this case, the region setting unit 102 sets the sensor information processing amount according to the magnitude of the ground deformation. Specifically, the region setting unit 102 sets the sensor information processing amount in such a way that the larger the magnitude of the ground deformation, the larger the sensor information processing amount. The region setting unit 102 outputs, to the sensor information processing unit 103, the specified region together with the set sensor information processing amount.

Here, the sensor information processing amount will be described. The sensor information processing amount is a sensor information processing amount used in the processing of acquiring the sensor information from the sensor information acquisition device. The processing of acquiring the sensor information is at least one of processing of acquiring the sensor information from the sensor information acquisition device (also simply referred to as “acquisition processing”), processing of uploading the sensor information acquired from the sensor information acquisition device to the state determination device (also simply referred to as “upload processing”), or processing of determining the state of the structure by the state determination unit 104 (also simply referred to as “state determination processing”). The sensor information processing amount used in the processing of acquiring the sensor information can be set by, for example, a frequency of processing the sensor information or a processing amount (for example, a bit rate) of a unit time for the sensor information used in one processing.

For example, in a case where the sensor information is an image (including a moving image and a still image), the sensor information processing amount in the acquisition processing is defined by a resolution of the image acquired from the drive recorder 520, the number of images captured by the drive recorder 520 per traveling distance, a traveling interval of the mobile object on which the drive recorder 520 is mounted, or the like. The region setting unit 102 can set, for example, a resolution such as 1920×1080, 1024×768, or 720×480 for each region as the resolution of the image acquired from the drive recorder 520. In addition, the region setting unit 102 can set, for each region, a frequency of acquiring the sensor information such as one image per traveling distance of 10 m, one image per traveling distance of 100 m, or no image in a predetermined section, as the number of images captured by the drive recorder 520 per traveling distance. For example, since it is difficult to clearly image the state of the structure at night or on a day with bad weather, the region setting unit 102 sets the number of images captured per traveling distance in such a way that a reduced number of images are captured or no image capturing is performed. The region setting unit 102 can set the traveling interval of the mobile object to, for example, every day, every week, every month, or not acquiring the traveling for a certain period. The region setting unit 102 sets the traveling interval in such a way as to increase the traveling interval, for example, in a season in which a ground deformation at a snow melting period in early spring is large. Furthermore, in a case where the sensor information is a moving image, the region setting unit 102 can set a frame rate of the moving image to be acquired for each region as the sensor information processing amount in the acquisition processing.

The sensor information processing amount in the upload processing is defined by, for example, a frequency of uploading of the sensor information acquired from the drive recorder 520. For example, in a case where the sensor information is an image, the region setting unit 102 can set a frequency of the image to be uploaded for each region in such a way as to upload all images acquired by the drive recorder 520 to the state determination device 10, upload some (for example, one of 10 sheets) of the images acquired by the drive recorder 520, or not to upload an image of a predetermined section. Furthermore, the frequency of uploading the image can be set in such a way that one image is uploaded every day, every week, or every month, or no image is uploaded for a predetermined period. In a case where the sensor information is a moving image, the region setting unit 102 can set a frame rate of the moving image to be uploaded to the state determination device 10 for each region as the sensor information processing amount in the upload processing.

The sensor information processing amount in the state determination processing is defined by, for example, a frequency of using the sensor information uploaded to the state determination device 10 for state determination. For example, in a case where the sensor information is an image, the region setting unit 102 can set the frequency used for state determination for each region in such a way as to use all the images uploaded to the state determination device 10 for state determination, use some of the uploaded images (for example, one of 10 images) for state determination, or not to use an image in a predetermined section for state determination. In addition, the frequency of using the image for state determination can be set in such a way as to use one image every day, every week, or every month, or no image is used for a predetermined period. In a case where the sensor information is a moving image, the region setting unit 102 can set a frame rate of the moving image to be used by the state determination unit 104 for structure state determination for each region as the sensor information processing amount in the state determination processing.

The region setting unit 102 may set a fixed value as the sensor information processing amount set for each predetermined region described above, or may receive a value set by a user from an input device (not illustrated). Furthermore, the processing amount of the sensor information uploaded by the drive recorder 520 to the state determination device 10 and the processing amount of the sensor information in the acquisition processing may be different from each other.

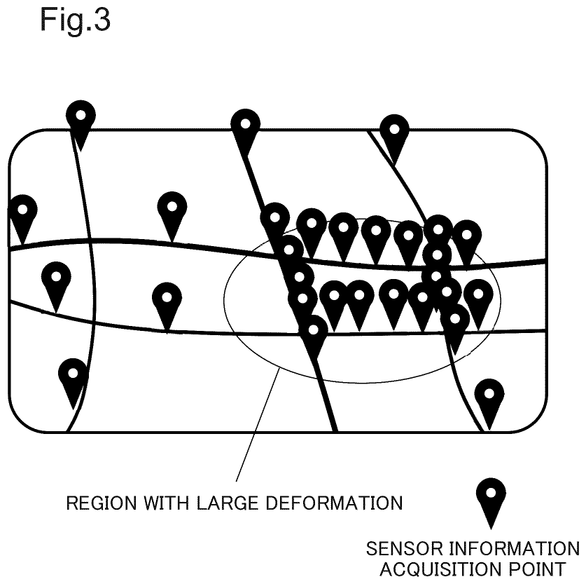

An example of this case will be described with reference to the drawings. FIG. 3 is a diagram for describing an example of acquisition in the processing of acquiring the sensor information from the sensor information acquisition device by the sensor information processing unit 103 according to the first example embodiment. In FIG. 3, the line is a road. The ellipse is a region with a large ground deformation set by the region setting unit 102. The region setting unit 102 sets the sensor information processing amounts for the elliptical region and the other regions. For example, the region setting unit 102 sets the frame rate (processing amount) of the sensor information acquired by the sensor information acquisition device mounted on the drive recorder 520. For example, when traveling on a road included in the elliptical range, the region setting unit 102 increases the frame rate (for example, 30 fps) of the sensor information. On the other hand, when traveling on a road other than the road included in the elliptical range, the region setting unit 102 decreases the frame rate (for example, 1 fps) of the sensor information. The sensor information processing unit 103 can set a frequency of acquiring the sensor information in a range of, for example, 0 (sensor information is not acquired) to 60 fps. Furthermore, the sensor information processing unit 103 can similarly set the frame rate in the sensor information upload processing or the state determination processing. For example, the sensor information processing unit 103 can set the frame rate to 30 fps in the acquisition processing, 15 fps in the upload processing, and 10 fps in the state determination processing for a predetermined region. In this case, the sensor information processing unit 103 decreases the frame rate of the sensor information acquired from the sensor information acquisition device and uploads the sensor information to the state determination device 10. Furthermore, the sensor information processing unit 103 further decreases the frame rate of the uploaded sensor information and outputs (that is, state determination by the state determination unit 104) the sensor information to the state determination unit 104.

As described above, the region setting unit 102 may specify a region in which it is estimated that the degree of deterioration of the structure is high, such as a banked region or a region with a larger ground deformation due to sinking than predicted, even if the ground deformation is not larger than the threshold. For example, in a case of a ground deformation correlated with construction, the region setting unit 102 specifies a region with a larger ground deformation than predicted based on information related to the construction. In addition, in a case of a region where a building exists, the region setting unit 102 specifies a region where an inclination of each building is larger than a ground deformation predicted by machine learning using strata and a precipitation amount. On the other hand, in a case of some types of the ground, there is a region where the ground deformation is not correlated with the climate or temperature. The region setting unit 102 does not have to specify such a region because the ground deformation is as predicted.

The sensor information processing unit 103 processes the sensor information based on the sensor information processing amount associated to the region set by the region setting unit 102. The processing of the sensor information is, for example, acquisition of the sensor information, upload of the sensor information to the state determination device, or output of the sensor information to the state determination unit 104. The sensor information processing unit 103 acquires the sensor information according to the sensor information processing amount (data acquisition amount) associated to a region including position information during traveling. The position information includes, for example, a position on a map, latitude and longitude, and position information obtained by global navigation satellite system (GNSS) or global positioning system (GPS). In addition, when acquiring the sensor information, the sensor information processing unit 103 acquires information regarding a date and time when the sensor information is acquired and a position where the sensor information is captured together with the sensor information.

The sensor information processing unit 103 uploads the sensor information or inputs the sensor information to the state determination unit 104 according to the sensor information processing amount associated to the region including the position information at which the sensor information is acquired. The sensor information processing unit 103 outputs the sensor information to the state determination unit 104 while processing the sensor information in this manner.

The state determination unit 104 determines the state of the structure by using the sensor information input by the sensor information processing unit 103. The state determination unit 104 determines a deterioration state of the structure by using, for example, a model obtained by learning an image obtained by capturing an image of the structure as the sensor information and the sensor information such as an acceleration, as training data. In the present example embodiment, a method for determining a state of deterioration of a road as the structure will be described.

The road deterioration is deterioration that occurs on a paved road due to factors such as traveling of vehicles and rainfall. There are a plurality of types of road deterioration. The road deterioration is classified into a plurality of types including, for example, a crack, a pot hole, rutting, and road surface irregularity. The crack may be classified into different types including a linear crack and a tortoise-shell crack depending on the shape. The linear crack is a single linear crack. The tortoise-shell crack is, for example, a tortoise-shell shaped crack generated when vertical and horizontal linear cracks are connected. The crack on a road generally tends to progress toward a linear crack, a tortoise-shell crack, and a pot hole.

Various indices are used as indices indicating the degree of road deterioration. In the present disclosure, the degree of road deterioration is represented by the degree of deterioration. The degree of deterioration may be any one of indexes including the degree of cracking, the number of pot holes, a size of the pot hole, a rutting amount, and a flatness. In addition, the degree of deterioration may be determined based on a combination of a plurality of indexes indicating the degree of road deterioration.

The degree of cracking is represented by any one of a shape, a length, an area, and the number of cracks, or a combination thereof. A crack rate is an example of the degree of cracking. The crack rate is represented by, for example, 100×(area of cracking/area of road section). In this case, the value of the degree of deterioration ranges from 0% to 100%. The area of cracking is calculated by any method. A method for calculating the crack rate is not particularly limited, and a known calculation method can be applied in addition to the above.

The size of the pot hole is represented by, for example, any one of an area, a width, a length, and a depth of the pot hole, or a combination thereof. The rutting amount is a depth of rutting at which a traveling track of the vehicle becomes lower than other road surfaces due to a load of the vehicle and friction with tires.

The degree of cracking, the number and size of pot holes, and the rutting amount may be calculated based on measurement data obtained by measuring a road surface with a sensor. Alternatively, the indices may be calculated based on a result of recognizing road deterioration from an image obtained by capturing an image of the road.

The flatness may be represented by an International Roughness Index (IRI). The IRI is an index in which a road surface and a ride comfort of a driver are associated with each other, and represents the degree of unevenness as a numerical value. The IRI may be calculated based on measurement data obtained by measuring a road surface with a sensor. Alternatively, the IRI may be calculated based on a value of an acceleration sensor attached to the vehicle during traveling. Specifically, for example, the IRI is calculated based on a value of an acceleration in the vertical direction included in accelerations acquired at a detection position. A method for calculating the IRI is not limited to the above, and a known calculation method can be adopted.

The degree of deterioration is not limited to the above-described indices, and for example, any index representing road deterioration including a maintenance control index (MCI) may be used. A value of the MCI is the minimum value of a result of calculating four definition equations using the crack rate, the rutting amount, and the flatness. The MCI decreases as the road deteriorates.

The output unit 105 outputs the state of the structure determined by the state determination unit 104 to a predetermined notification destination. For example, once the state determination unit 104 determines the deterioration state of the road, the output unit 105 notifies a predetermined notification destination of information indicating the position and the degree of deterioration of the road determined by the state determination unit 104. The output unit 105 may select a notification destination. The output unit 105 may output to, for example, the terminal device 540 of a road manager such as a local government.

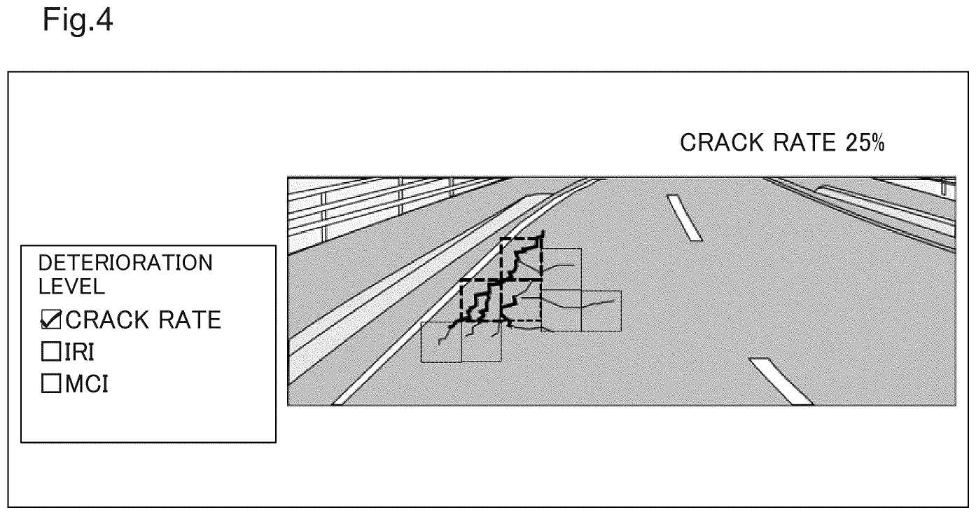

Here, an example of the state of the structure output by the output unit 105 will be described. FIG. 4 is a diagram illustrating an example of an output of the output unit according to the first example embodiment. As illustrated in FIG. 4, the output unit 105 may display and acquire an index indicating the degree of road deterioration together with a road image of a point designated by the user. FIG. 4 illustrates an image obtained by capturing a road on which a vehicle runs, and the image is captured by, for example, a camera mounted on a front side of the vehicle traveling in a left lane. The road in FIG. 4 has a crack at a left end of the road, and the crack is surrounded by dotted lines having different thicknesses depending on the size of the crack. In addition, in the example of FIG. 4, an index indicating the degree of road deterioration to be displayed can be selected, and in the example of FIG. 4, only the crack rate is displayed. The crack rate increases when the degree of deterioration increases. The manner of representing the degree of deterioration is not limited thereto, and for example, the value of the degree of deterioration may decrease when the degree of deterioration becomes higher.

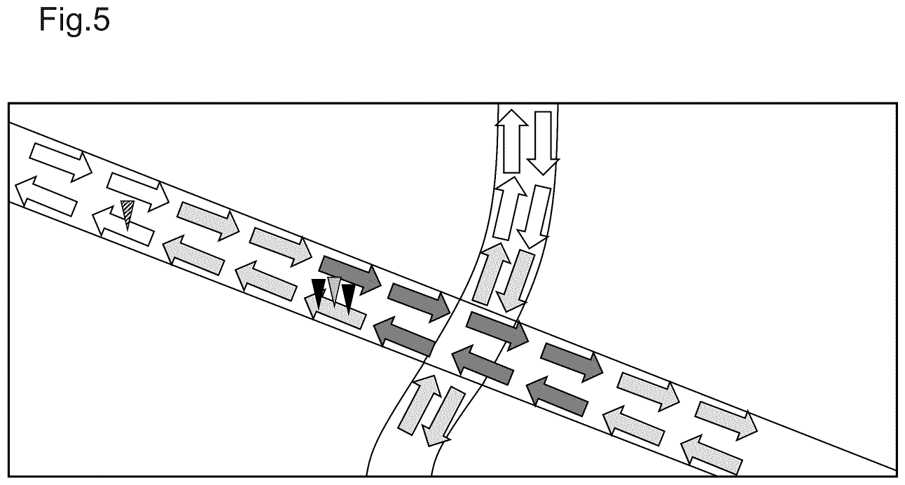

FIG. 5 is a diagram illustrating another example of the output of the output unit according to the first example embodiment. In the example of the output in FIG. 5, the crack rate is represented by an arrow indicating three levels of shading for each unit obtained by dividing the road surface of the road by a predetermined section, and a higher level of shading indicates a higher crack rate. The crack rate for each unit may be an average value or the maximum value of the crack rates at a plurality of places calculated in the unit, or may be a value calculated by other statistical processing. In the example of the output in FIG. 5, the direction of the arrow varies between a downward direction and an upward direction.

Furthermore, in the example of the display in FIG. 5, the output unit 105 displays a crack width with a level of shading of an inverted triangle that is a predetermined symbol. For example, the crack width is divided into three stages of less than 5 mm, less than 5 to 10 mm, and 10 mm or more, and a higher level of shading indicates a larger crack width. In order to represent the crack width, the output unit 105 may display a predetermined symbol of an inverted triangle at each position where the crack is detected.

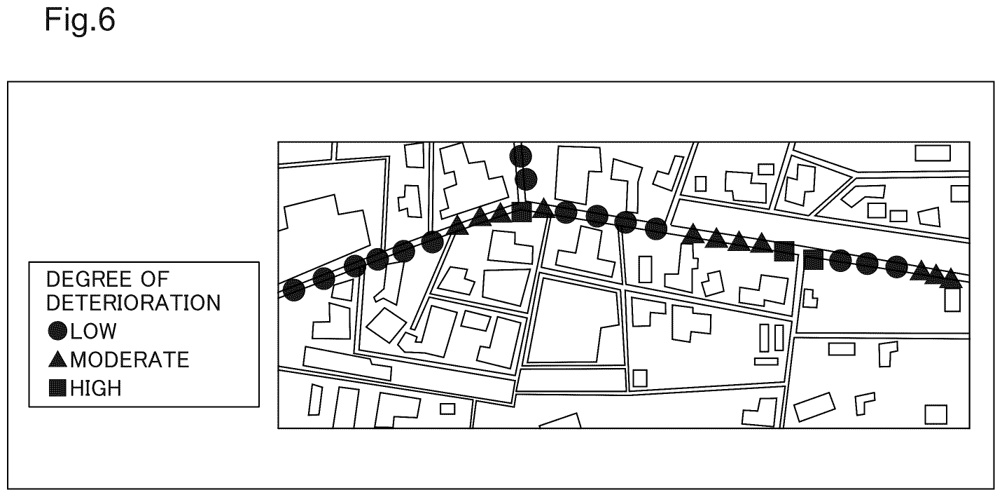

FIG. 6 is a diagram illustrating another example of the output of the output unit according to the first example embodiment. As illustrated in FIG. 6, the output unit 105 may display the position and the degree of deterioration (for example, the crack rate) of the road determined by the state determination unit 104 on a road map. In the example of FIG. 6, the degree of deterioration is indicated by symbols of three stages of “high”, “moderate”, and “low”.

### Description of Operation

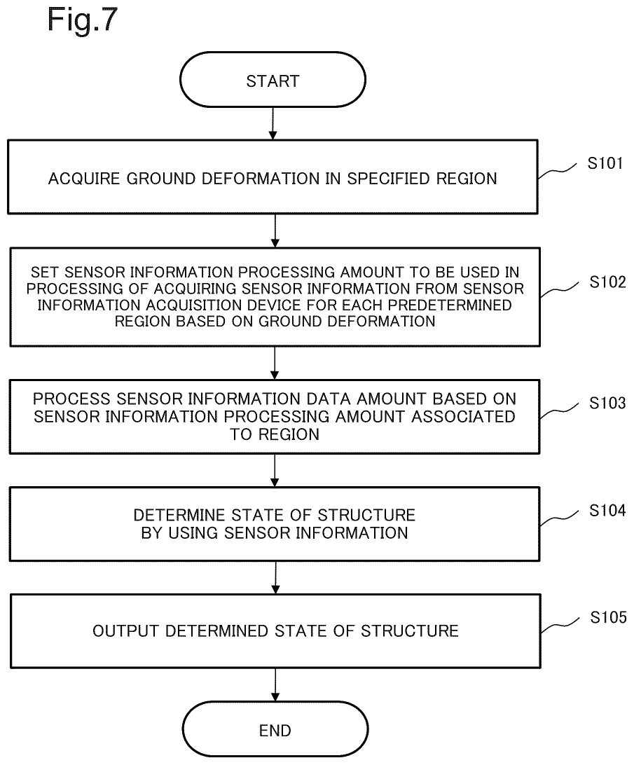

FIG. 7 is a flowchart illustrating an example of an operation of the state determination device 10 according to the first example embodiment. The ground information acquisition unit 101 acquires a ground deformation in a specified region (step S101). The region setting unit 102 sets a sensor information processing amount to be used in the processing of acquiring the sensor information from the sensor information acquisition device for each predetermined region based on the ground deformation (step S102). Next, the sensor information processing unit 103 processes the sensor information data amount based on the sensor information processing amount associated to the region set by the region setting unit 102 (step S103). The state determination unit 104 determines the state of the structure by using the sensor information (step S104). Next, the output unit 105 outputs the state of the structure determined by the state determination unit 104 (step S105).

In the state determination device 10, the sensor information processing unit 103 processes the sensor information data amount based on the sensor information processing amount associated to the region set by the region setting unit 102. As a result, the data amount of the sensor information used for processing up to the structure state determination can be adjusted based on the magnitude of the ground deformation acquired from the ground measurement device (for example, the SAR 530). For example, the state determination device 10 can increase the data amount of the sensor information used for the structure state determination in a region with a large ground deformation, reduce the data amount of the sensor information used for the structure state determination in a region with a small ground deformation, and the like. Therefore, with the state determination device 10, it is possible to appropriately determine the state of the structure while reducing the sensor information processing amount.

In addition, the state determination device 10 outputs the state of the structure determined by the state determination unit 104. As a result, it is possible to provide detailed information of the structure in a region with a large ground deformation to the user or the like while reducing the sensor information processing amount.

### [Hardware Configuration]

Next, a hardware configuration of the state determination device 10 will be described. Each component of the state determination device 10 may be implemented by a hardware circuit. Alternatively, in the state determination device 10, each component may be implemented using a plurality of devices connected via a network. For example, the state determination device 10 may be implemented using cloud computing. Alternatively, in the state determination device 10, a plurality of components may be implemented by one piece of hardware. Alternatively, the state determination device 10 may be implemented as a computer device including a central processing unit (CPU), a read only memory (ROM), and a random access memory (RAM). The state determination device 10 may be implemented as a computer device including a network interface circuit (NIC) in addition to the above configuration.

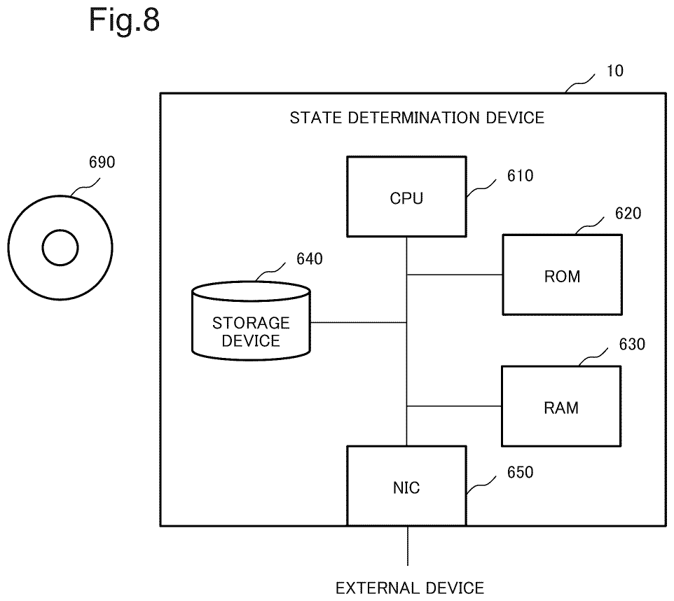

FIG. 8 is a block diagram illustrating an example of a hardware configuration of the state determination device 10. The state determination device 10 includes a CPU 610, a ROM 620, a RAM 630, a storage device 640, and an NIC 650, and configures a computer device. The CPU 610 reads a program from the ROM 620 and/or the storage device 640. Then, the CPU 610 controls the RAM 630, the storage device 640, and the NIC 650 based on the read program. Then, the computer including the CPU 610 controls the components, and implements the functions of the ground information acquisition unit 101, the region setting unit 102, the sensor information processing unit 103, the state determination unit 104, and the output unit 105 illustrated in FIG. 1.

When implementing each function, the CPU 610 may use the RAM 630 or the storage device 640 as a temporary storage medium for programs and data. Alternatively, the CPU 610 may read a program included in a recording medium 690 storing the program in a computer readable manner by using a recording medium reading device (not illustrated). Alternatively, the CPU 610 may receive a program from an external device (not illustrated) via the NIC 650, store the program in the RAM 630 or the storage device 640, and operate based on the stored program.

The ROM 620 stores programs to be executed by the CPU 610 and fixed data. The ROM 620 is, for example, a programmable ROM (P-ROM) or a flash ROM. The RAM 630 temporarily stores programs to be executed by the CPU 610 and data. The RAM 630 is, for example, a dynamic-RAM (D-RAM). The storage device 640 stores data and programs to be stored for a long period of time by the state determination device 10. Furthermore, the storage device 640 may operate as a temporary storage device of the CPU 610. The storage device 640 is, for example, a hard disk device, a magneto-optical disk device, a solid state drive (SSD), or a disk array device. The ROM 620 and the storage device 640 are non-volatile (non-transitory) recording media. Meanwhile, the RAM 630 is a volatile (transitory) recording medium. The CPU 610 is operable based on a program stored in the ROM 620, the storage device 640, or the RAM 630. That is, the CPU 610 can operate using a non-volatile recording medium or a volatile recording medium.

The NIC 650 relays exchange of data with an external device (the drive recorder 520, the SAR 530, the terminal device 540, or the like) via a network. The NIC 650 is, for example, a local area network (LAN) card. Furthermore, the NIC 650 is not limited to be used for wired communication, and may be used for wireless communication. The state determination device 10 configured as described above can obtain an effect similar to that of the state determination device 10 in FIG. 1. This is because the CPU 610 of the state determination device 10 can implement the same function as that of the state determination device 10 in FIG. 1 based on the program.

### Second Example Embodiment

Next, a second example embodiment of the present disclosure will be described in detail with reference to the drawings. Hereinafter, a description of contents overlapping with the above description will be omitted unless the description of the present example embodiment is unclear.

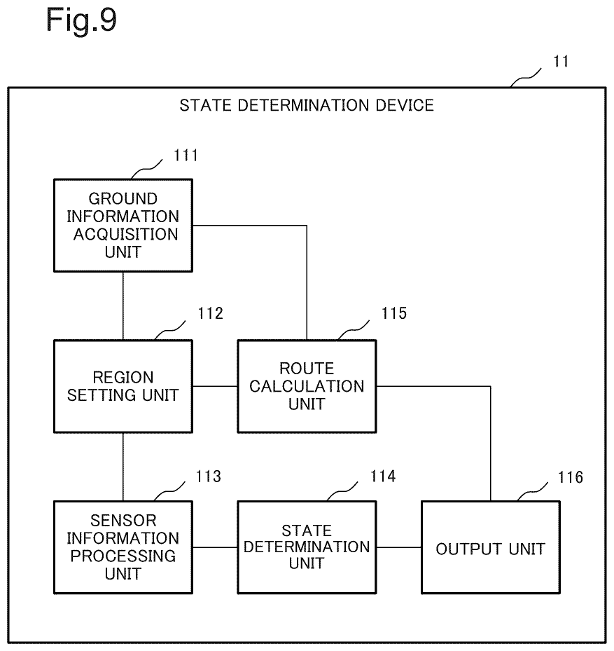

FIG. 9 is a block diagram illustrating an example of a configuration of a state determination device 11 according to the second example embodiment. The state determination device 11 includes a ground information acquisition unit 111, a region setting unit 112, a sensor information processing unit 113, a state determination unit 114, a route calculation unit 115, and an output unit 116. The second example embodiment is different from the first example embodiment in that the route calculation unit 115 is provided. Since the components other than the route calculation unit 115 and the output unit 116 are similar to the corresponding components of the first example embodiment, a description thereof is omitted.

The route calculation unit 115 calculates a route for a vehicle to travel in a region for which a sensor information processing amount is set to be higher than a threshold by the region setting unit 112. The region for which the sensor information processing amount is set to be higher than the threshold is a region with a ground deformation larger than a predetermined threshold. The route calculation unit 115 includes the set region in the route and searches for a route from a designated departure point to a destination. Traveling in the set region means, for example, traveling in the set region or around the set region. When a mobile object travels along the calculated route, the sensor information processing unit 230 acquires sensor information on the route with the processing amount set by the region setting unit 112. For example, the route calculation unit 250 acquires, for example, an image of a road as the sensor information from a drive recorder 520. The route calculation unit 250 may acquire the sensor information from the drive recorder 520 or may acquire the sensor information from a device that stores the sensor information acquired by the drive recorder 520.

The departure point and the destination of the route are not particularly limited. The route calculation unit 115 may acquire at least one of a road, a departure point, a transit point, or a destination for which a route is to be searched from a user or the like. In this case, a state of a structure in the set region can be determined while the mobile object travels along the route designated by the user.

The output unit 116 outputs route information calculated by the route calculation unit 115 to a predetermined notification destination in addition to the state of the structure determined by the state determination unit 114. A device as the notification destination may be any device as long as the device is mounted on the mobile object.

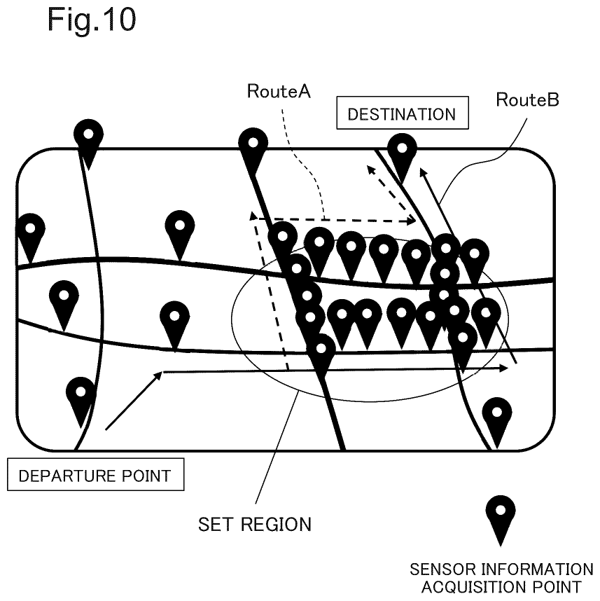

FIG. 10 is a diagram illustrating an example of the route information according to the second example embodiment. As illustrated in FIG. 10, there are two types of routes RouteA and RouteB for traveling in the set region and traveling from the designated departure point to the destination. In a case where the sensor information in the set region is not acquired, both the routes RouteA and RouteB may be presented. In addition, in a case where the sensor information on either one of the pieces of route information (for example, the route RouteA) has already been acquired, only the other piece of route information (the route RouteB) may be displayed. In this case, it is possible to efficiently acquire pieces of sensor information of different points in a region with a large ground deformation.

The route information may include a structure different from the road. For example, the route information may include information related to whether a person can pass through a staircase, a pedestrian bridge, a sidewalk at an upper portion of a bank or a top end of an embankment, a road in a park, a walk, a farm road, or a platform. The route information may be generated using information related to a plurality of structures.

### Description of Operation

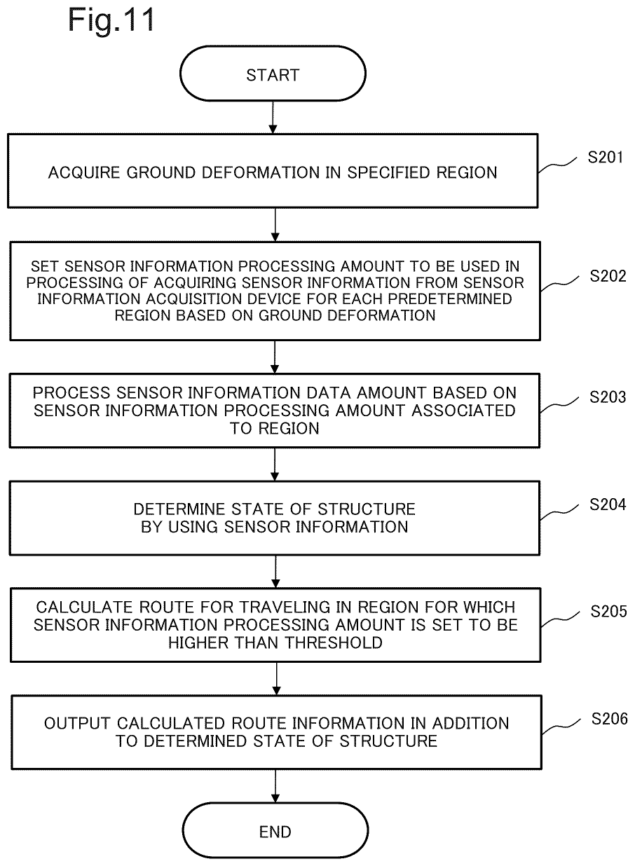

FIG. 11 is a flowchart illustrating an example of an operation of the state determination device 11 according to the second example embodiment. Since steps S201 to S204 in the present example embodiment are similar to steps S101 to S104 in the first example embodiment, a description thereof is omitted. The route calculation unit 115 calculates a route for traveling in a region for which the sensor information processing amount is set to be higher than the threshold by the region setting unit 112 (step S205). Finally, the output unit 116 outputs the route information calculated by the route calculation unit 115 in addition to the state of the structure determined by the state determination unit 114 (step S206).

In the state determination device 11 according to the second example embodiment, the route calculation unit 115 calculates a route for the vehicle to travel in a region for which the sensor information processing amount is set to be higher than the threshold by the region setting unit 112. As a result, the mobile object travels along the calculated route, so that the sensor information of a region with a large ground deformation can be preferentially acquired. Therefore, it is possible to quickly determine the state of a region where there is a possibility of deterioration of the structure. In particular, with the state determination device 11, it is possible to output route information for acquiring sensor information of a structure whose state is to be determined next while the output unit 116 outputs a result of determining the state of the structure. Therefore, the structure state determination can be efficiently performed.

Some or all of the above-described example embodiments can also be described as the following Supplementary Notes, but are not limited thereto.

### Supplementary Note 1

A state determination device including:
ground surface information acquisition means configured to acquire a ground deformation by using a measurement image acquired from a ground measurement device;
region setting means configured to set, for each predetermined region, a sensor information processing amount to be used in processing of acquiring sensor information from a sensor information acquisition device based on the ground deformation;
sensor information processing means configured to process the sensor information based on the sensor information processing amount associated to the set region;
state determination means configured to determine a state of a structure by using the processed sensor information; and
output means configured to output the determined state of the structure.

### Supplementary Note 2

The state determination device according to Supplementary Note 1, in which
the processing of acquiring the sensor information is at least one of processing of acquiring the sensor information from the sensor information acquisition device, processing of uploading the sensor information acquired from the sensor information acquisition device to the state determination device, or processing of determining the state of the structure by the state determination means.

### Supplementary Note 3

The state determination device according to Supplementary Note 1 or 2, in which
the region setting means sets a frequency of processing the sensor information for each region.

### Supplementary Note 4

The state determination device according to any one of Supplementary Notes 1 to 3, in which
the sensor information is a moving image, and
the region setting means sets a frame rate of the moving image for each region.

### Supplementary Note 5

The state determination device according to any one of Supplementary Notes 1 to 4, in which
the sensor information is the sensor information related to a structure on which a mobile object on which the sensor information acquisition device is mounted travels.

### Supplementary Note 6

The state determination device according to Supplementary Note 5, in which
the structure is a road, and
the mobile object is a vehicle traveling on the road.

### Supplementary Note 7

The state determination device according to any one of Supplementary Notes 1 to 6, in which
the sensor information processing means acquires a captured image obtained by capturing an image of the structure as the sensor information, and
the output means displays information indicating the state of the structure on the captured image.

### Supplementary Note 8

The state determination device according to any one of Supplementary Notes 1 to 6, in which
the output means displays information indicating a degree of deterioration of the structure on a map.

### Supplementary Note 9

The state determination device according to Supplementary Note 7 or 8, in which
the output means displays, as the information indicating the degree of deterioration of the structure, an index indicating a degree of road deterioration of at least one of a crack, a pot hole, rutting, or road surface irregularity.

### Supplementary Note 10

The state determination device according to any one of Supplementary Notes 1 to 9, further including
route calculation means configured to calculate a route for a vehicle to travel in a region for which the sensor information processing amount is set to be higher than a predetermined threshold by the region setting means,
in which the output means outputs the calculated route information in addition to the determined state of the structure.

### Supplementary Note 11

A condition determination method including:
acquiring a ground deformation by using a measurement image acquired from a ground measurement device;
setting, for each predetermined region, a sensor information processing amount to be used in processing of acquiring sensor information from a sensor information acquisition device based on the ground deformation;
processing the sensor information based on the sensor information processing amount associated to the set region;
determining a state of a structure by using the processed sensor information; and
outputting the determined state of the structure.

### Supplementary Note 12

A recording medium that records a program for causing a computer to execute:
acquiring a ground deformation by using a measurement image acquired from a ground measurement device;
setting, for each predetermined region, a sensor information processing amount to be used in processing of acquiring sensor information from a sensor information acquisition device based on the ground deformation;
processing the sensor information based on the sensor information processing amount associated to the set region;
determining a state of a structure by using the processed sensor information; and
outputting the determined state of the structure.

While the present invention has been particularly shown and described with reference to the example embodiments thereof, the present invention is not limited to these example embodiments. It will be understood by those of ordinary skill in the art that various changes in form and details may be made therein without departing from the spirit and scope of the present invention as defined by the claims.

### REFERENCE SIGNS LIST

10, 11 state determination device
101, 111 ground information acquisition unit
102, 112 region setting unit
103, 113 sensor information processing unit
104, 114 state determination unit
105, 116 output unit
115 route calculation unit
510 computer
520 drive recorder
530 SAR
540 terminal device
550 vehicle
580 network
610 CPU
620 ROM
630 RAM
640 storage device
650 NIC

What is claimed is:

1. A state determination device comprising:
a memory storing instructions; and
at least one processor configured to execute the instructions to:
acquire a ground deformation by using a measurement image acquired from a ground measurement device;
set, for each predetermined region, a sensor information processing amount to be used in processing of acquiring sensor information from a sensor information acquisition device based on the ground deformation;
process the sensor information based on the sensor information processing amount associated to the set region;
determine a state of a structure by using the processed sensor information; and
output the determined state of the structure.

2. The state determination device according to claim 1, wherein
the processing of acquiring the sensor information is at least one of processing of acquiring the sensor information from the sensor information acquisition device, processing of uploading the sensor information acquired from the sensor information acquisition device to the state determination device, or processing of determining the state of the structure.

3. The state determination device according to claim 1, wherein the at least one processor is further configured to execute the instructions to:
set a frequency of processing the sensor information for each region as the sensor information processing amount.

4. The state determination device according to claim 1, wherein
the sensor information is a moving image, and the at least one processor is further configured to execute the instructions to:
set a frame rate of the moving image for each region as the sensor information processing amount.

5. The state determination device according to claim 1, wherein
the sensor information is the sensor information related to a structure on which a mobile object on which the sensor information acquisition device is mounted travels.

6. The state determination device according to claim 5, wherein
the structure is a road, and
the mobile object is a vehicle traveling on the road.

7. The state determination device according to claim 1, wherein the at least one processor is further configured to execute the instructions to:
acquire a captured image obtained by capturing an image of the structure as the sensor information, and
display information indicating a degree of deterioration of the structure together with the captured image.

8. The state determination device according to claim 1, wherein the at least one processor is further configured to execute the instructions to:
display information indicating a degree of deterioration of the structure on a map.

9. The state determination device according to claim 7, wherein the at least one processor is further configured to execute the instructions to:
display, as the information indicating the degree of deterioration of the structure, an index indicating a degree of road deterioration of at least one of a crack, a pot hole, rutting, or road surface irregularity.

10. The state determination device according to claim 1, wherein the at least one processor is further configured to execute the instructions to:
calculate a route for a vehicle to travel in a region for which the sensor information processing amount is set to be higher than a predetermined threshold, and
output the calculated route information in addition to the determined state of the structure.

11. A condition determination method comprising:
acquiring a ground deformation by using a measurement image acquired from a ground measurement device;
setting, for each predetermined region, a sensor information processing amount to be used in processing of acquiring sensor information from a sensor information acquisition device based on the ground deformation;
processing the sensor information based on the sensor information processing amount associated to the set region;
determining a state of a structure by using the processed sensor information; and
outputting the determined state of the structure.

12. A non-transitory computer recording medium that records a program for causing a computer to execute:
acquiring a ground deformation by using a measurement image acquired from a ground measurement device;
setting, for each predetermined region, a sensor information processing amount to be used in processing of acquiring sensor information from a sensor information acquisition device based on the ground deformation;
processing the sensor information based on the sensor information processing amount associated to the set region;
determining a state of a structure by using the processed sensor information; and
outputting the determined state of the structure.
